(19) United States
(12) Patent Application Publication
(10) Pub. No.: US 2017/0076240 A1
(43) Pub. Date: Mar. 16, 2017

(54) Apparatus to Present Leaderboards for Associate-Level Performance Statistics

(71) Applicant: Wal-Mart Stores, Inc., Bentonville, AR (US)

(72) Inventors: Zulfiqar A. Paracha, Bentonville, AR (US); Ryan W. Travis, Fayetteville, AR (US); Wallace C. King, Rogers, AR (US); Brian Harrison, Little Rock, AR (US); William R. Piech, Rogers, AR (US); Mahesh S. Thangaraj, Centerton, AR (US); Brian D. Burge, Centerton, AR (US); Anthony W. Helms, Bentonville, AR (US); Derric D'souza, Bentonville, AR (US); Kevin E. Hill, Bentonville, AR (US); Nirmal Unnikrishnan, Bentonville, AR (US); Michael S. McGuire, Bentonville, AR (US); Larry M. Tyler, II, Wentzville, MO (US); Michael Andrew Budell Fischer, Bentonville, AR (US); Darrell V. Waurio, Bella Vista, AR (US)

(21) Appl. No.: 15/261,266

(22) Filed: Sep. 9, 2016

Related U.S. Application Data
(60) Provisional application No. 62/216,864, filed on Sep. 10, 2015.

(51) Int. Cl. G06Q 10/06

(52) U.S. Cl. CPC G06Q 10/06398

(57) ABSTRACT

A control circuit for a retail sales facility presents via an active display a plurality of leaderboards that correspond to a variety of different associate-level performance statistics. These statistics can include, but are not limited to, the number of products that a given associate picks as part of moving products from a stock area to the retail sales product display area (over, for example, a given amount of time) and/or an aggregated monetary value of products that are so picked, a number of products that are so picked exclusively from a particular area of the product stock area, a number of manually-created requirements to so move products, and/or a number of products that are placed for storage in the product stock area itself. Such statistics can represent any time period of choice including, for example, a particular work shift such as a current work shift.

### CROSS-REFERENCE TO RELATED APPLICATION

This application claims the benefit of U.S. Provisional Application No. 62/216,864, filed Sep. 10, 2015, and is incorporated herein by reference in its entirety.

### TECHNICAL FIELD

These teachings relate generally to retail sales facilities.

### BACKGROUND

A modern retail store can be very large and accommodate the display of tens or even hundreds of thousands of different products being offered for retail sale. Numerous factors can impact profitability for the enterprise that operates the store. As one example in these regards, it is usually important that products on display in the retail sales product display area of the store be replenished from time to time to ensure that items are available for purchase. As another example, it can be important that new products be properly placed on the retail sales floor quickly and efficiently to again ensure the timely availability such products for retail sale.

Associates for the enterprise that operates a given retail sales facility are often tasked with moving items from a product stock area to the retail sales product display area (or to accomplish intermediate tasks in those regards, such as moving items from one area in the product stock area to another are in preparation to move those items to the sales floor). Numerous activities and corresponding metrics often characterize and/or serve to represent such a task. These metrics can help management to better understand the performance of individual associates.

Generally speaking, however, modern retailers do not effectively share such information (at least on a regular basis) with the associates themselves. Accordingly, any performance-based motivation that might be directly or indirectly derived from such information gathering is the result, to at least some large extent, of whatever self-motivation the individual associate might muster. Under these circumstances, even the most eager and determined of associates is typically unable to gauge their own performance against their local and/or other-store co-workers. As a result, self-monitoring associates can incorrectly gauge their own performance as it stacks up against other associates and then incorrectly conclude that they are good, or poor, performers.

Confusion and lack of transparency in these regards is perhaps at least partially responsible for unwarranted anxiety and/or undue complacency. These conditions may also help contribute to a less-satisfying work experience that can, in turn, lead to associate boredom or loss of focus that in turns can lead to reduced productivity and hence reduced profitability.

### BRIEF DESCRIPTION OF THE DRAWINGS

The above needs are at least partially met through provision of the apparatus to present leaderboards for associate-level performance statistics described in the following detailed description, particularly when studied in conjunction with the drawings, wherein:

FIG. 1 comprises a block diagram as configured in accordance with various embodiments of these teachings;

FIG. 2 comprises a perspective schematic view as configured in accordance with various embodiments of these teachings;

FIG. 3 comprises a flow diagram as configured in accordance with various embodiments of these teachings;

FIG. 4 comprises a screen shot as configured in accordance with various embodiments of these teachings;

FIG. 5 comprises a screen shot as configured in accordance with various embodiments of these teachings;

FIG. 6 comprises a screen shot as configured in accordance with various embodiments of these teachings; and

FIG. 7 comprises a screen shot as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a control circuit for a retail sales facility presents via an active display a plurality of leaderboards that correspond to a variety of different associate-level performance statistics. These teachings will accommodate a wide variety of such statistics including, but not limited to, the number of products that a given associate picks as part of moving products from a stock area to the retail sales product display area (over, for example, a given amount of time) and/or an aggregated monetary value of products that are so picked, a number of products that are so picked exclusively from a particular area of the product stock area, a number of manually-created requirements to so move products, and/or a number of products that are placed for storage in the product stock area itself. Such statistics can represent any time period of choice including, for example, a particular work shift such as a current work shift.

By one approach these statistics represent only associates and their performance statistics for a single retail sales facility. By another approach, in lieu of the foregoing or in combination therewith, these statistics can represent a plurality of retail sales facilities. For example, a retail sales facility leaderboard for a particular associate-level performance statistic can represent that statistic as aggregated on a facility-wide basis (i.e., over a number of relevant associates) for each of that plurality of retail sales facilities.

The aforementioned active display can be placed, for example, in the product stock area and hence can be available for any associate that might choose to view these leaderboards. This availability may be continuous or may only be provided on a sporadic basis (such as during two minute windows of time every fifteen minutes) as desired.

So configured, associates can have access to information regarding their own statistics and/or to the statistics for the highest-performing associates (either, for example, at their own store and/or any number of other stores). Associates can then use such information to gauge their own absolute and relative performance.

In addition, many associates will enjoy the kind of competition that such leaderboards can help engender. This can include both individual competition (i.e., their own individual performance as compared against that of others) as well as team competition (for example, the overall performance of a given group of associates at one store in comparison to groups from other stores). Such competition can help to alleviate or otherwise avoid boredom and monotony and hence can lead to greater associate satisfaction.

These teachings are highly flexible in practice and can accommodate a wide variety of modifications and/or combinations. These teachings can also be carried out in an economical manner.

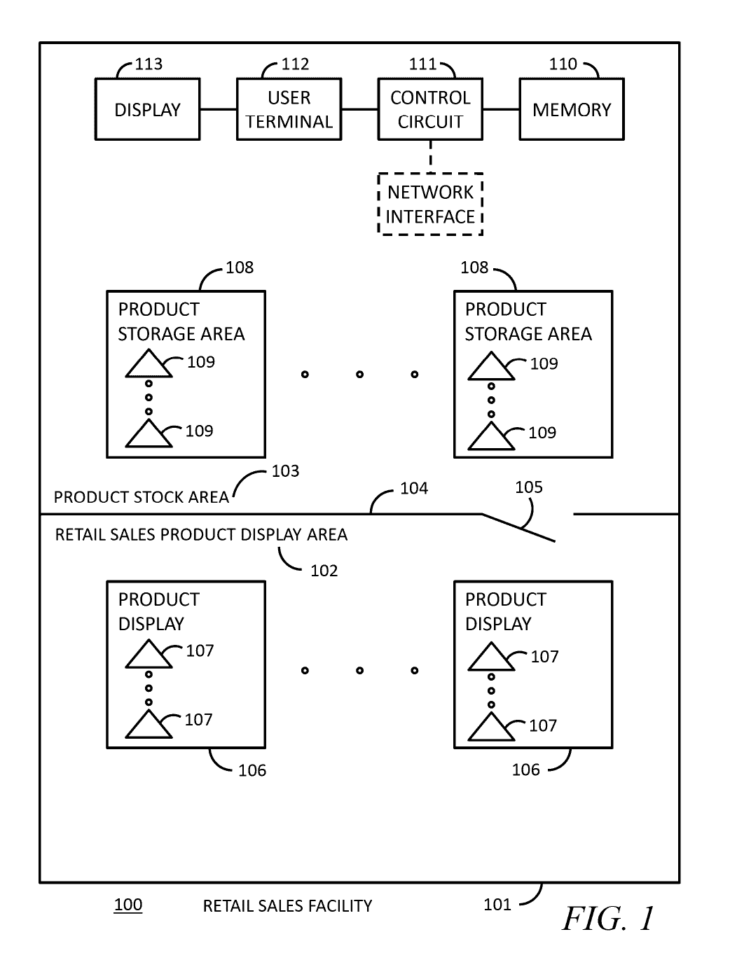

These and other benefits may become clearer upon making a thorough review and study of the following detailed description. FIG. 1 presents a retail store assistance system 100 that includes a retail sales facility 101. In this example this retail sales facility 100 comprises a traditional (as versus virtual) retail store having a physical presence that customers can physically enter to inspect and select their desired products and make their corresponding purchases. This retail sales facility 101 includes a retail product display area 102 comprising a first partitioned area of the retail sales facility 101 and a product stock area 103 that is, in this example, physically separated from the retail sales product display area by at least one wall 104. At least one portal 105 permits passage between these two areas 102 and 103. This portal 105 may or may not include a movable barrier such as a door as desired.

The retail sales product display area 102 includes a plurality of product displays 106. These product displays 106 are configured to present products 107 that are being offered for retail sale at the retail sales facility 101. These product displays 106 can be relatively formal and comprise such things as shelves, end caps, racks, and the like. These teachings will also accommodate product displays 106 that are less formal and comprise, for example, display tables, pallets, open boxes, and so forth. There is no requirement that the product displays 106 for a given retail sales facility 101 all have an identical size and/or form factor.

It will also be presumed that in a typical application setting the products 107 can vary from one product display 106 to the next and even within a given one of the product displays 106. These teachings will also accommodate displaying products 107 in a boxed or unboxed manner as desired. Generally speaking, the shopping paradigm will presume that the customer can take such a product 107 from such a product display 106 to a point of sale (POS) in order to purchase the product 107.

The product stock area 103, in turn, includes a plurality of product storage areas 108. These product storage areas 108 are each configured to store products 109 as undisplayed inventory (that is, products that are available to sell but which have not yet been placed in the retail sales product display area 102 and hence are not yet directly available to a consumer for inspection). As with the aforementioned product displays 106 these teachings will accommodate a variety of different product storage areas 108 having a variety of form factors and/or sizes and varying as well with respect to how formal or informal those areas might be.

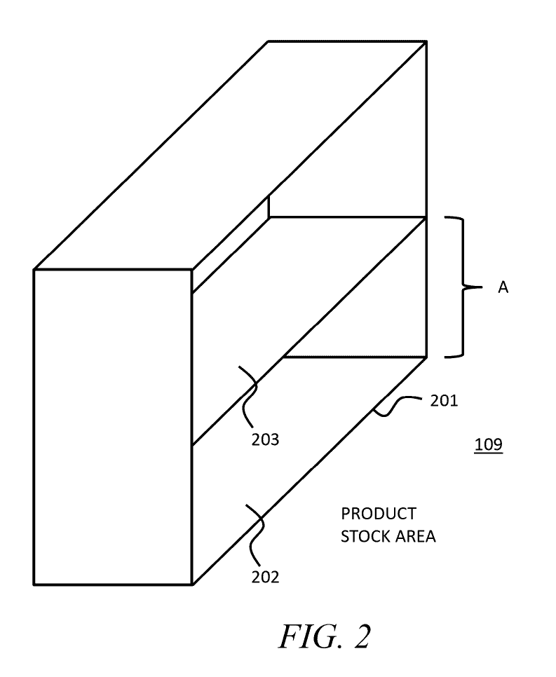

Referring momentarily to FIG. 2, by one approach at least one of these product storage areas 108 comprises a shelving unit 201. In the simple example shown, this shelving unit 201 comprises a lower shelf 202 and an upper shelf 203. In this example the upper shelf 203 is A inches above the lower shelf 202 (where “A” might be, for example, 60 inches). In an application setting where A represents a threshold height, the upper shelf 203 would therefore constitute an area of the product stock area 103 that is higher than the threshold height A.

Referring again to FIG. 1, the retail store assistance system 100 further includes a memory 110 having data stored therein regarding a plurality of different associate-level performance statistics as regards products at the retail sales facility 100. This memory 110 operably couples to a control circuit 111 which in turn operably couples to a user terminal hundred and 12 and/or a display 113.

Being a “circuit,” the control circuit 111 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 111 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 111 is configured (for example, by using corresponding programming as will be well understood by those skilled in the art) to carry out one or more of the steps, actions, and/or functions described herein.

The memory 110 may be integral to the control circuit 111 or can be physically discrete (in whole or in part) from the control circuit 111 as desired. This memory 110 can also be local with respect to the control circuit 111 (where, for example, both share a common circuit board, chassis, power supply, and/or housing) or can be partially or wholly remote with respect to the control circuit 111 (where, for example, the memory 110 is physically located in another facility, metropolitan area, or even country as compared to the control circuit 111).

In addition to the aforementioned data regarding a plurality of different associate-level performance statistics, this memory 110 can serve, for example, to non-transitorily store the computer instructions that, when executed by the control circuit 111, cause the control circuit 111 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

The user terminal 112 can comprise any of a variety of user-input mechanisms (such as, but not limited to, keyboards and keypads, cursor-control devices, touch-sensitive displays, speech-recognition interfaces, gesture-recognition interfaces, and so forth). The display 113 can comprise any of a variety of active displays that present video content, and therefore include computer monitors, television flat-panel screens, and so forth. As the present teachings are not overly sensitive to any particular selections in these regards, further elaboration is not provided here. In many application settings it will likely be beneficial if the display 113 is physically located in the product stock area 103 in an area where associates employed at the retail sales facility 101 can view the display 113.

As noted above, the memory 110 has data stored therein regarding a plurality of different associate-level performance statistics as regards products at the retail sales facility. These teachings will accommodate a wide variety of statistics in these regards. As used herein, the expression “associate-level” will be understood to refer to performance statistics for individual associates. Although these teachings can be leveraged to also work with statistics of team-level, shift-level, store-level, and/or even district-level performance, the memory 110 will at least have statistics representing that associate-level of activity.

For many application settings these associate-level performance statistics will represent a performance metric over some relevant period of time. The relevant period of time might comprise, for example, one hour, two hours, and so forth. By another related approach, the relevant period of time could correspond to a work shift (such as a four hour work shift, an eight hour work shift, or the like).

In some cases the relevant period of time has closed. This can be the case, for example, when considering the performance of an associate during a two-hour period of the preceding day. In other cases the relevant period of time can remain currently open. This can be the case, for example, when considering a current work shift that began, say, at 10 PM and that will end at, say, 6 AM, and it is only 1 AM at the present time.

In some cases the relevant period of time represents only a contiguous block of time such as from 10 PM to 6 AM the following day. In other cases the relevant period of time represents an aggregation of a plurality of temporally separated blocks of time. For example, the relevant period of time may represent a block of time from 10 AM to 4 PM on each weekday for a given week.

By one approach the associate-level performance statistics include statistics regarding the number of products that are picked (that is, physically selected and moved) by individual associates as part of moving the products from the product stock area 103 to the retail sales product display area 102. In some cases the statistics can pertain to products that are picked and hence moved but not necessarily to the retail sales product display area 102 from the product stock area 103. Instead, a product can be picked in order to move the product from a bin, trailer, shelf or the like to a staging area in order to get the product ready to move to the retail sales product display area 102. As one simple example in these regards, products may be moved to and placed on a pallet in the product stock area 103 such that the pallet can later be moved to the retail sales product display area 102 in order to facilitate moving those picked products to their appropriate respective destinations.

Such a statistic can correlate to individual products (for example, 123 gallons of milk) or to some other metric that correlates to, for example, pre-packaged or cartonized products (for example, shipping cartons that each include 4 gallons of milk) as desired.

By another approach the associate-level performance statistics include statistics regarding an aggregated monetary value of products that are picked as part of moving the products from the product stock area 103 to the retail sales product display area 102. For example, if a particular associate picked 123 gallons of milk and each gallon of milk sold at retail for $2.50, the aggregated monetary value would be $307.50By one approach the aggregated monetary value represents the retail value of the product. By another approach the aggregated monetary value represents the cost of the product to the enterprise that operates the retail sales facility 101. These teachings will accommodate other measures of monetary value as well if desired.

By another approach the associate-level performance statistics include statistics regarding a number of products that are picked exclusively from a particular area of the product stock area 103 as part of moving the products from the product stock area 103 to the retail sales product display area 102. As one illustrative example in these regards and without intending any particular limitations by way of the specificity of this example, the aforementioned particular area might constitute an area of the product stock area 102 that is higher than a threshold height as illustrated in FIG. 2 by the letter A. Such a statistic can help differentiate the efforts of associates when some associates might be picking a disproportionate number of products from areas that are more difficult to physically access (requiring, for example, the use of the ladder). Such a statistic can help, for example, to better normalize a comparison of individual performance statistics amongst a plurality of associates.

By another approach the associate-level performance statistics include statistics regarding a number of manually-created requirements to move products from the product stock area 103 to the retail sales product display area 102. In some cases some or all of the picks are identified and/or scheduled by a manager or non-supervisory associate. (In some cases some or all of the picks may be automatically generated by, for example, a background system that tracks the sale of products and can detect when picks are required to replenish product inventory on the retail sales product display area 102.) To the extent that picks are created by a person, the number of picks created by individual associates can constitute the aforementioned manually-created requirements.

By yet another approach the associate-level performance statistics include statistics regarding a number of products that are placed for storage in the product stock area 103. This activity is sometimes known in the art as binning. This can include, for example, products that are moved into the product stock area 103 from a loading dock or the like. This can also include, in lieu of the foregoing or in combination therewith, products that are moved from the retail sales product display area 102 into the product stock area 103.

The metrics upon which such associate-level performance statistics are based can be captured in the first instance in any of a variety of ways. By one simple approach one or more associates can be tasked with maintaining the corresponding counts and making the corresponding calculations where appropriate. By another approach the individuals performing these tasks can maintain their own records in these regards. These teachings will also accommodate, however, partially or wholly-automated approaches to gathering the metrics. By one approach, for example, the individual products can each be provided with a radio-frequency identification (RFID) tag having a unique corresponding identifier that correlates to the product. RFID-tag readers can then be used to determine, for example, when a product (and which products) are removed from a particular area in the product stock area 103 and/or placed elsewhere in the product stock area 103 or moved out through the portal 105 to the retail sales product display area 102. By yet another approach, in lieu of the foregoing or in combination therewith, video information that captures these tasks can be automatically processed to identify which products are moved, from where to where, and when. As the present teachings are not particularly sensitive to any particular choices in these regards, further elaboration regarding such approaches is not provided here.

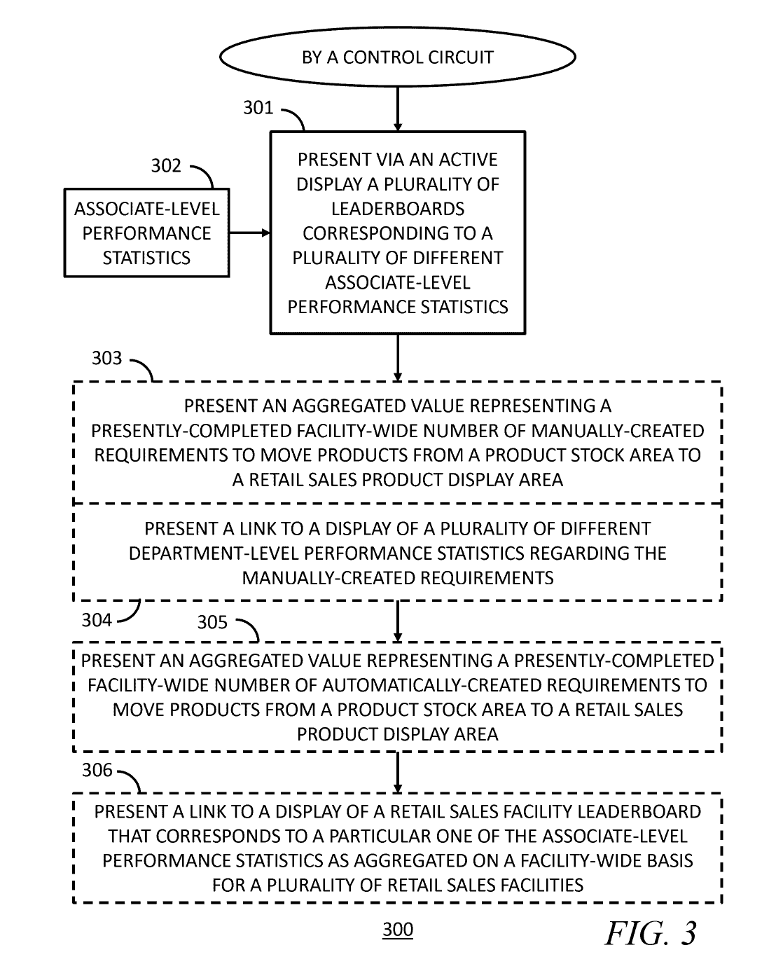

FIG. 3 presents an illustrative process 300 that is compatible with many of these teachings. In this illustrative example the aforementioned control circuit 111 carries out the process 300.

At block 301 the control circuit 111 accesses the aforementioned associate-level performance statistics 302 from the memory 110 and presents, via the aforementioned display 113, a plurality of leaderboards that correspond to that plurality of different associate-level performance statistics. The particular leaderboards employed and so presented can vary with the needs and/or opportunities as tend to characterize a given application setting.

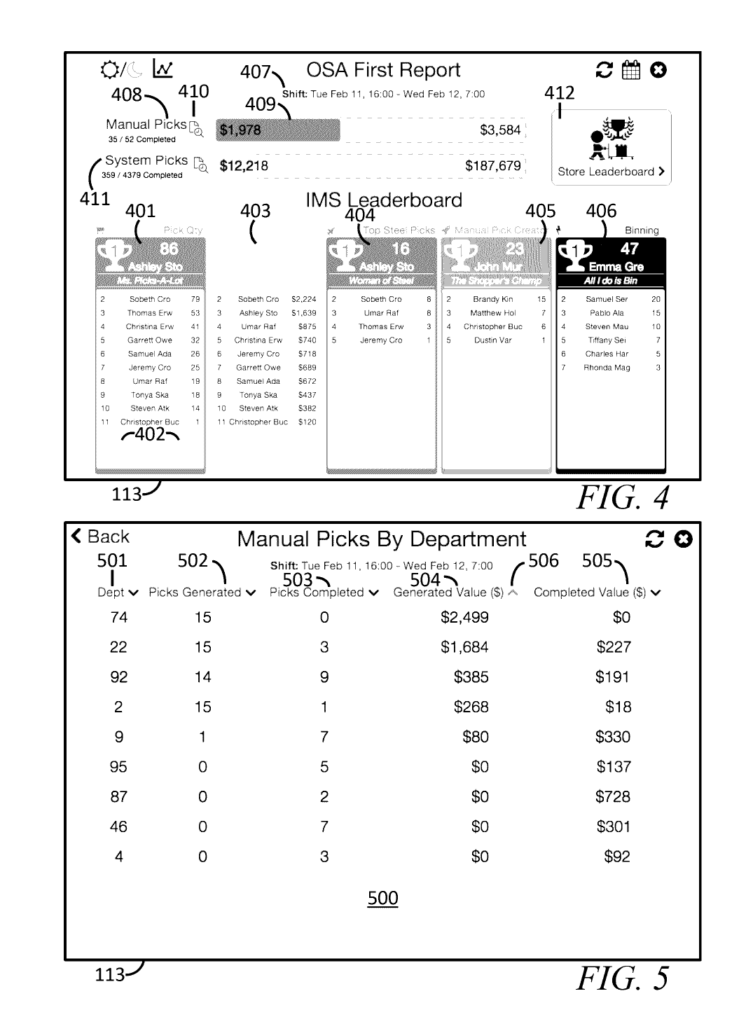

FIG. 4 presents an illustrative example in these regards. In this example the control circuit 111 presents via the display 113, simultaneously, five different associate-level performance statistics-based leaderboards. In this example it is presumed that the leaderboards pertain to the performance of associates during a particular shift, which shift has not yet concluded and hence the information portrayed is subject to change during the remainder of that shift.

In this example a first leaderboard 401 depicts performance with respect to the number of products picked by the identified associates. In this example the leading associate (having the name Ashley Sto) appears at the top of the leaderboard in larger font than the remaining listed associates and in conjunction with a winner's cup that bears the numeral “1” to signify this associate's currently leading status in this statistical category. The number 86 also appears and indicates the number of picks currently achieved by this associate. (In this example the expression “Ms. Picks-a-Lot” also appears near the name of the leading associate to serve as a kind of complementary appellation in recognition of this associate's achievement. By one approach this expression is selected by management (perhaps from a pool of candidate acceptable expressions). By another approach the associate preselects for themselves such a title.)

This first leaderboard 401 then presents other associates along with their number of presently-picked products and their respective ranking vis-à-vis other associates at this particular retail sales facility 101. Scrolling buttons 402 are provided at the bottom of this first leaderboard 401 in order to permit scrolling this leaderboard display in order to see other associates who do not presently appear in this particular displayed group.

A second leaderboard 403 corresponds to the aggregated monetary value as corresponds to the current volume of picks for these associates. In this illustrative example the value represents the retail value of the picked products. This second leaderboard 403 utilizes the same form factor and look as the first leaderboard 401. Accordingly, the currently-leading associate (in this example, an associate named Thomas Enw) appears at the top of the leaderboard in the number 1 position with other associates also appearing in their respective places as per the value of their respective picks. In the right-most column the monetary value, in US dollars, of the picks for each associate appears. This example serves to also illustrate that the associate who picked the greatest quantity of products is not necessarily the associate who picks products representing the greatest value.

A third leaderboard 404 corresponds to only picks of products that were located higher than a threshold height (referred to here as “top steel picks”). This third leaderboard 404 again utilizes the same form factor and look as the first and second leaderboards 401 and 403. In this case the right-most column represents the number of qualifying picks for this particular performance metric for each listed associate. Associates who did not pick any qualifying products per this statistic are not listed in this example. These teachings will accommodate listing such associates if desired along with, for example, the value “0” in the right-most column.

As noted above the associate-level performance statistics can include statistics regarding a number of manually-created requirements to move products from the product stock area 103 to the retail sales product display area 102. The fourth leaderboard 405 presents statistics in those regards. Again, this fourth leaderboard 405 utilizes the same form factor and look as before.

This illustrative example also includes a fifth leaderboard 406 that presents statistics regarding the quantity of products that are placed for storage in the product stock area 103. As before, this fifth leaderboard 406 utilizes the same form factor and look as before.

As already noted, in this example all of the displayed leaderboards use a same form factor and look although the specific statistics represented of course vary from one leaderboard to the next. If desired, each leaderboard can be presented using a different color. These teachings will also accommodate presenting one or more of the leaderboards using a different appearance if desired.

The data and rankings presented in these leaderboards can be updated as frequently or infrequently as desired. By one approach these leaderboards are not presented until the time being considered has concluded. By another approach these leaderboards are presented during the time period of interest and are updated on either a regular or irregular basis. When updated periodically, these teachings will accommodate updating the leaderboards at some regular interval of choice such as every 1 minute, every 5 minutes, every 15 minutes, every hour, and so forth. When irregularly updated, these teachings will accommodate, for example, updating any leaderboard where a particular metric increments by at least some predetermined amount (where, for example, a particular associate increases their performance metric by some predetermined amount or percentage). By another approach, in lieu of the foregoing or in combination therewith, a leaderboard can be automatically updated when any associate's ranking changes. By yet another approach the leaderboard may only be automatically updated when an associate achieves the number 1 ranking. These teachings will accommodate any number of other approaches in these regards as desired.

These teachings are highly flexible in practice and will accommodate a wide variety of variations and/or additions as desired. For example, animation can be used to emphasize a particular achievement such as newly achieving a number 1 ranking on one of the leaderboards. These teachings will also accommodate supplementing the presentation of these leaderboards with corresponding audio content. That audio content can range from simple sound effects to audibly reading the contents of one or more of the leaderboards.

In this example the display 113 presents information 407 regarding the timeframe to which the leaderboard information pertains. As an illustrative example, FIG. 4 presents leaderboards pertaining to a work shift that begins at 4 PM on Tuesday, February 11 and concludes at 7 AM on Wednesday, February 12.

With continued reference to FIGS. 3 and 4, at block 303 the control circuit 111 also presents an aggregated value representing a presently completed facility-wide number of manually-created requirements to move products from the product stock area 103 to the retail sales product display area 102, and in particular information 408 regarding an aggregation of data pertaining to manual picks. This information 408 includes a presentation of how many manual picks have been completed so far in the timeframe of interest and how many manual picks there are in total to complete. In particular, in this example 35 manual picks have been completed out of a total of 52 manual picks needing completion.

Reference numeral 409 indicates (at the left) the monetary value of the currently-completed manual picks as well as (at the right) the total monetary value as corresponds to all of the scheduled manual picks. Color, shading, or the like can help to represent current progress in these regards.

Pursuant to optional block 304, the control circuit 111 can also present a report icon 410 that comprises a link to a display of a plurality of different department-level performance statistics regarding the manually-created requirements. So configured, clicking on this icon 410 brings up a detailed report. FIG. 5 presents an illustrative example in these regards. This report 500 of Manual Picks By Department represents the same timeframe as the display in FIG. 4. This illustrative report 500 presents a variety of metrics for each of a plurality of departments of the retail sales facility 101 in a plurality of columns.

The first column 501 represents each department by a corresponding assigned identifying number. The second column 502 indicates the number of manual picks that were generated by the corresponding department. The third column 503 indicates the number of those picks that have been completed. The fourth column 504 indicates the monetary value of the aggregated generated picks while the fifth column 505 indicates the aggregated monetary value of the completed picks.

In this example each column includes a small arrow-like icon. Selecting this icon for any of the columns permits the rows to be sorted in an ascending or descending fashion. In this example the icon denoted by reference numeral 506 has been clicked and therefore the rows are ordered (department by department) with respect to descending values of the monetary value of the generated manual picks.

Referring again to FIGS. 3 and 4, at optional block 305 the control circuit 111 presents an aggregated value representing a presently-completed facility-wide number of automatically-created requirements to move products from the product stock area 103 to the retail sales product display area 102. In the illustrated example this aggregated value appears in conjunction with the information provided at reference numeral 411. This presentation of metrics generally corresponds to the presentation described above for the manual picks information 408.

At optional block 306 the control circuit 111 presents a link 412 to a display of a retail sales facility leaderboard that corresponds to a particular one of the associate-level performance statistics as aggregated on a facility-wide basis for a plurality of retail sales facilities. By one approach this retail sales facility leaderboard can represent all of the retail sales facilities operated by a particular enterprise. By another approach this retail sales facility leaderboard represents a subset of those retail sales facilities (for example, all of the retail sales facilities in a particular geographic region such as a county or state).

FIG. 6 presents an illustrative example of such a retail sales facility leaderboard 600. In this example the associate-level performance statistic corresponds to the number of picked products. By one approach this leaderboard can utilize the same approach as was described above to thereby present the stores in descending order beginning with the highest-performing store. In the illustrative example presented in FIG. 6, the leaderboard 600 is modified to present the aggregated pick value information for the current retail sales facility 101 (having identification number store 100 as per the identification protocol of the enterprise that operates the stores) above the otherwise ranked presentation of aggregated values for the remaining retail sales facilities. Accordingly, the highest ranked store (in this example, a store that also happens to be represented by the identifier store 1) appears second in the leaderboard listing, followed by the second highest ranked store (i.e., store 5260) and so forth. The current performance rankings are indicated in the far column 601 on the right. In this example, each row also indicates, both graphically and numerically, the number of picks achieved in the aggregate by all associates during the time period of interest at the respective retail sales facility. Navigation buttons 602 appear at the bottom of the display 113 to permit, for example, the user to scroll through the available data to see similar information for other retail sales facilities.

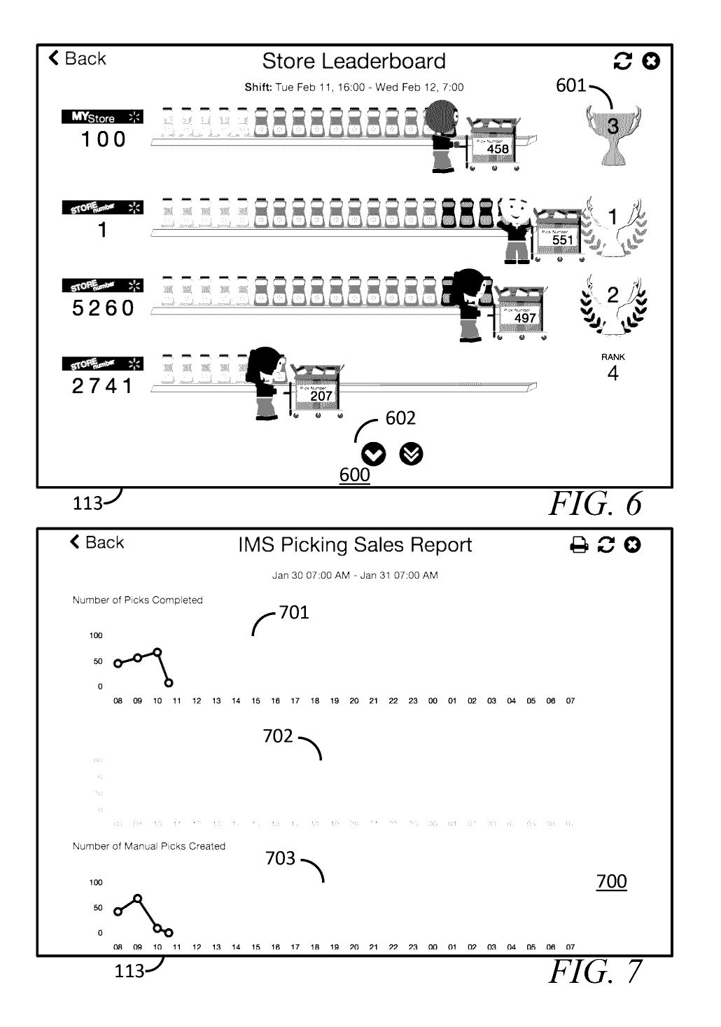

The statistics and data available to the control circuit 111 as per the foregoing teachings can be leveraged in other ways as desired. FIG. 7 provides one illustrative example in these regards. This example comprises a picking sales report 700 for an indicated 24 hour interval of interest. A first graph 701 in this report 700 indicates how many picks were completed on an hourly basis. In this example the picks were all completed by 11 PM and hence there are no picks to report thereafter. A second graph 702 in this report 700 indicates the number of completed bin audits in a similar manner. And a third graph 703 in this report 700 indicates how many manual picks were created during this timeframe in a similar manner. These teachings will accommodate a wide variety of other reports as desired.

So configured, this retail store assistance system provides useful information in a helpful, intuitive, and even entertaining way. The information can be helpful to managers as well as associates and provides a straightforward and relatively objective way by which associates can gauge and assess their own day-to-day improvement in performance and with respect to their peers, both locally and elsewhere within the enterprise. The natural sense of competition engendered by a leaderboard, in turn, can help avert boredom and monotony in a positive way.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A retail store assistance system comprising:
a retail sales facility having:
a retail sales product display area having a plurality of product displays configured to present products being offered for retail sale;
a product stock area having a plurality of product storage areas configured to store products as undisplayed inventory;
at least one user terminal having an active display;
a memory having stored therein data regarding a plurality of different associate-level performance statistics as regards products at the retail sales facility;
a control circuit operably coupled to the memory and the user terminal and configured to present via the active display a plurality of leaderboards corresponding to the plurality of different associate-level performance statistics.

2. The retail store assistance system of claim 1 wherein the plurality of different associate-level performance statistics include statistics regarding:
a number of products that are picked as part of moving the products from the product stock area to the retail sales product display area; and
an aggregated monetary value of products that are picked as part of moving the products from the product stock area to the retail sales product display area.

3. The retail store assistance system of claim 2 wherein the plurality of different associate-level performance statistics further include statistics regarding:
a number of products that are picked exclusively from a particular area of the product stock area as part of moving the products from the product stock area to the retail sales product display area.

4. The retail store assistance system of claim 3 wherein the particular area of the product stock area constitutes an area of the product stock area that is higher than a threshold height.

5. The retail store assistance system of claim 2 wherein the plurality of different associate-level performance statistics further include statistics regarding:
a number of manually-created requirements to move products from the product stock area to the retail sales product display area.

6. The retail store assistance system of claim 2 wherein the plurality of different associate-level performance statistics further include statistics regarding:
a number of products that are placed for storage in the product stock area.

7. The retail store assistance system of claim 2 wherein the plurality of different associate-level performance statistics further include statistics regarding:
a number of products that are picked exclusively from a particular area of the product stock area as part of moving the products from the product stock area to the retail sales product display area;
a number of manually-created requirements to move products from the product stock area to the retail sales product display area; and
a number of products that are placed for storage in the product stock area.

8. The retail store assistance system of claim 1 wherein the plurality of different associate-level performance statistics correspond to a current work shift.

9. The retail store assistance system of claim 8 wherein the plurality of different associate-level performance statistics correspond to only the current work shift.

10. The retail store assistance system of claim 1 wherein the control circuit is further configured to also present via the active display, while displaying the plurality of leaderboards corresponding to the plurality of different associate-level performance statistics, a link to a display of a retail sales facility leaderboard that corresponds to a particular one of the associate-level performance statistics as aggregated on a facility-wide basis for a plurality of retail sales facilities.

11. The retail store assistance system of claim 10 wherein the plurality of retail sales facilities comprise a subset of all retail sales facilities that are operated by a particular retailer.

12. The retail store assistance system of claim 10 wherein the retail sales facility leaderboard presents an aggregated value for the particular one of the associate-level performance statistics for the retail sales facility above a ranked presentation of aggregated values for the particular one of the associate-level performance statistics for the plurality of retail sales facilities.

13. The retail store assistance system of claim 1 wherein the control circuit is further configured to also present via the active display, while displaying the plurality of leaderboards corresponding to the plurality of different associate-level performance statistics, an aggregated value representing a presently-completed facility-wide number of manually-created requirements to move products from the product stock area to the retail sales product display area.

14. The retail store assistance system of claim 13 wherein the aggregated value is presented in conjunction with an aggregated value representing a facility-wide number of the manually-created requirements that are to be completed in total.

15. The retail store assistance system of claim 13 wherein the aggregated value is presented in conjunction with an aggregated value representing a monetary value that corresponds to the presently-completed facility-wide number of manually-created requirements.

16. The retail store assistance system of claim 15 wherein the aggregated value that represents the monetary value that corresponds to the presently-completed facility-wide number of manually-created requirements is presented in conjunction with an aggregated value representing a monetary value that corresponds to a facility-wide number of the manually-created requirements that are to be completed in total.

17. The retail store assistance system of claim 13 wherein the control circuit is further configured to also present via the active display, while displaying the aggregated value that represents a presently-completed facility-wide number of manually-created requirements to move products from the product stock area to the retail sales product display area, a link to a display of a plurality of different department-level performance statistics regarding the manually-created requirements.

18. The retail store assistance system of claim 17 wherein the display of the plurality of different department-level performance statistics is selectively sortable as a function of the different department-level performance statistics.

19. The retail store assistance system of claim 1 wherein the control circuit is further configured to also present via the active display, while displaying the plurality of leaderboards corresponding to the plurality of different associate-level performance statistics, an aggregated value representing a presently-completed facility-wide number of automatically-created requirements to move products from the product stock area to the retail sales product display area.

20. A non-transitory digital memory having computer instructions stored therein that, when executed by a processor, cause the processor to present via an active display a plurality of leaderboards corresponding to a plurality of different associate-level performance statistics as regards products at a retail sales facility.
